(19) United States
(12) Patent Application Publication
(10) Pub. No.: US 2004/0089119 A1
(43) Pub. Date: May 13, 2004

(54) Hand tool assembly having a small tool nested within a large tool

(76) Inventor: Li-Wen Kao, Tainan City (TW)

Correspondence Address: OSTROLENK FABER GERB & SOFFEN, 1180 AVENUE OF THE AMERICAS, NEW YORK, NY, 100368403

(21) Appl. No.: 10/293,724

(22) Filed: Nov. 12, 2002

(51) Int. Cl. B25B 23/00

(52) U.S. Cl. 81/439

(57) ABSTRACT

A hand tool assembly includes large and small tools. The large tool includes a large handle having a tool-storing hole that is defined by an inner wall face. The small tool includes a small handle having a front insert portion that is received within the tool-storing hole, and a front end flange that extends integrally, radially, and outwardly from a front end of the front insert portion and that has a rear edge. The rear edge is disposed in front of and abuts against projections on the inner wall face of the tool-storing hole so as to confine the small handle within the tool-storing hole.

### BACKGROUND OF THE INVENTION

1. Field of the Invention

The invention relates to a hand tool assembly, more particularly to a hand tool assembly that has a small tool and a large tool that are detachably connected to each other.

2. Description of the Related Art

A conventional hand tool assembly comprises a large tool and a small tool detachably connected to the large tool. The large tool includes a large handle and a long shank unit. The small tool includes a small handle and a short shank unit. The small handle is press-fitted into the large handle so as to form one body. When the large and small handles are separated, they can be used independently on a predetermined workpiece, such as a bolt, screw and nut, etc. Although the conventional hand tool assembly can achieve its intended purpose, there is a need to provide a hand tool assembly with a more reliable structure.

### SUMMARY OF THE INVENTION

Therefore, the main object of the present invention is to provide a hand tool assembly of the aforesaid type with a more reliable structure.

According to the present invention, a hand tool assembly comprises a large tool and a small tool. The large tool includes a large handle and a long shank unit. The large handle has a front end surface that is formed with a rearwardly extending shank hole, and a rear end surface that is formed with a frontwardly extending tool-storing hole that is defined by an inner wall face. The inner wall face is formed with a plurality of projections arranged along a circumferential direction of the large handle. The long shank unit has a front working end that is adapted to turn a threaded workpiece, and a rear engaging end that is inserted into the shank hole in the large handle and that is connected detachably to the large handle. The small tool includes a small handle and a short shank unit. The small handle has a front end surface that is formed with a shank hole, a front insert portion that is received within the tool-storing hole in the large handle, and a front end flange that extends integrally, radially, and outwardly from a front end of the front insert portion and that has a rear edge. The rear edge is disposed in front of and abuts against the projections so as to confine the small handle within the tool-storing hole. The short shank unit is shorter than the long shank unit, and has a front working end that is adapted to turn the threaded workpiece, and a rear engaging end that is inserted into the shank hole in the small handle and that is connected detachably to the small handle.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded partly sectional schematic view of the preferred embodiment of a hand tool assembly according to the present invention;

FIG. 2 is an enlarged sectional view of a large handle of the preferred embodiment taken along line II-II of FIG. 1, illustrating a plurality of projections of the large handle;

FIG. 3 is a partly sectional view of the preferred embodiment in an assembled state; and

FIG. 4 is a fragmentary enlarged sectional view of the preferred embodiment illustrating how a front end flange of a small handle is retained between a shoulder and the projections of the large handle.

### DETAILED DESCRIPTION OF THE PREFERRED EMBODIMENT

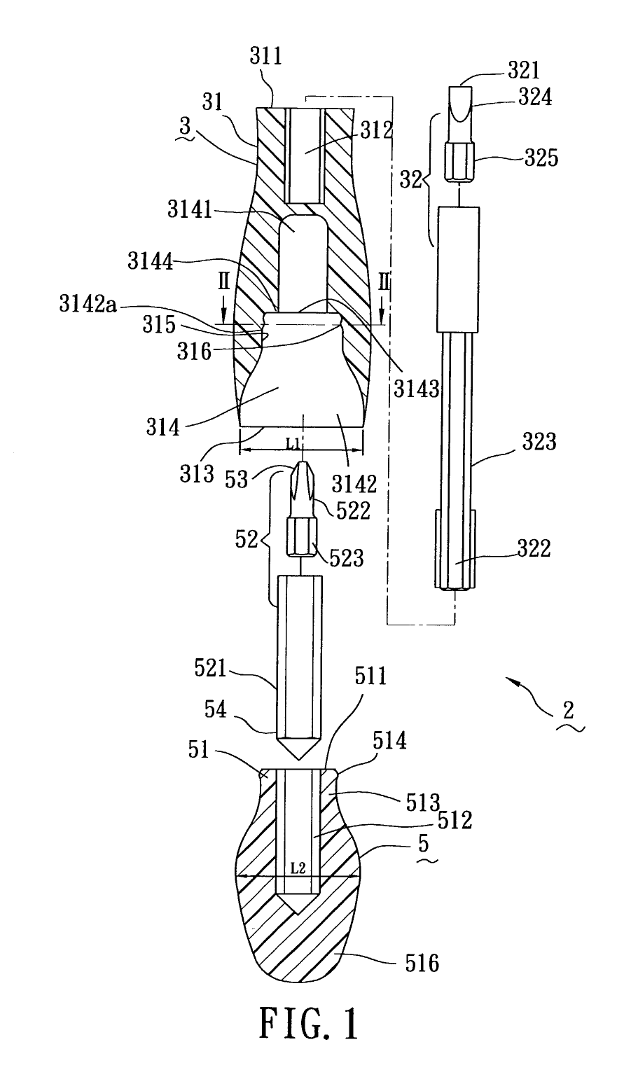

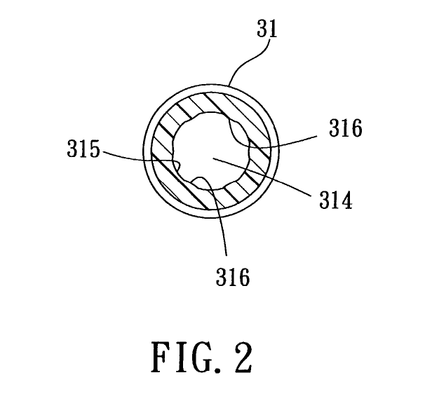

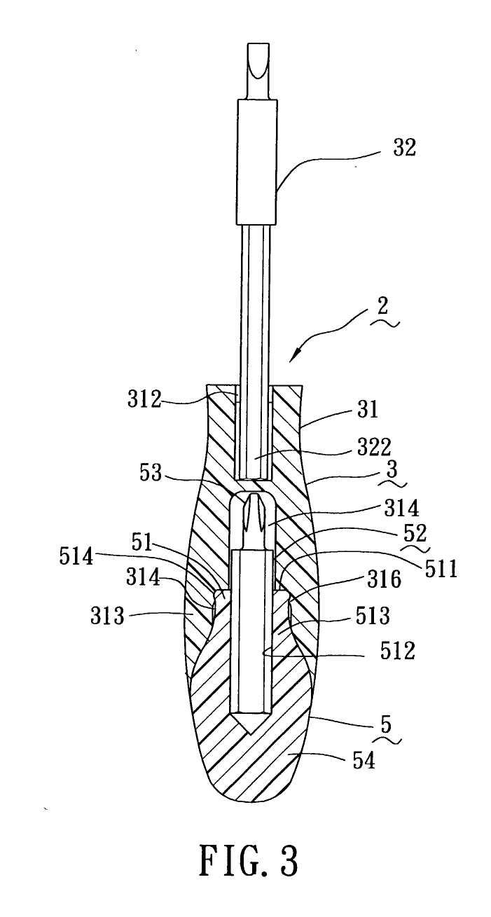

Referring to FIGS. 1, 2, 3, and 4, the preferred embodiment of a hand tool assembly 2 according to the present invention is shown to comprise a large tool 3 and a small tool 5, which are in the form of screwdrivers. The large tool 3 includes a large handle 31 and a long shank unit 32. The large handle 31 is made of plastic material, and has a front end surface 311 that is formed with a rearwardly extending shank hole 312, and a rear end surface 313 that is formed with a frontwardly extending tool-storing hole 314 that is defined by an inner wall face 315. The inner wall face 315 is formed with a plurality of projections 316 arranged along a circumferential direction of the large handle 31, as best shown in FIG. 2. The tool-storing hole 314 has a uniform-diameter front hole portion 3141 and a rearwardly diverging rear hole portion 3142 that has a minimum diameter at a front end 3143. The minimum diameter is larger than the uniform diameter of the front hole portion 3141 so as to define a shoulder 3144 between the front and rear hole portions 3141, 3142. The rear hole portion 3142 further has a diameter (L1) at a rear end.

The long shank unit 32 has a front working end 321 that is adapted to turn a threaded workpiece (not shown), such as a bolt, and a rear engaging end 322 that is inserted into the shank hole 312 in the large handle 31 and that is connected detachably and non-rotatably to the large handle 31. The long shank unit 32 includes a long shank body 323 that is formed with the rear engaging end 322 of the long shank unit 32, and a tool bit 324 that is formed with the front working end 321 of the long shank unit 32 and that has a rear end 325 that is connected detachably and non-rotatably to the long shank body 323. In this embodiment, the long shank unit 32 is designed with a replaceable tool bit 324, and can be replaced with a flat tip or a Phillips tip tool bit so as to conform to different types of workpieces. The rear engaging end 322 of the long shank unit 32 can be mounted with a ratchet mechanism (not shown) . Since the design transformation of the front working end 321 and the rear engaging end 322 of the long shank unit 32 is not pertinent to the claimed invention, a detailed description thereof will be dispensed with herein for the sake of brevity.

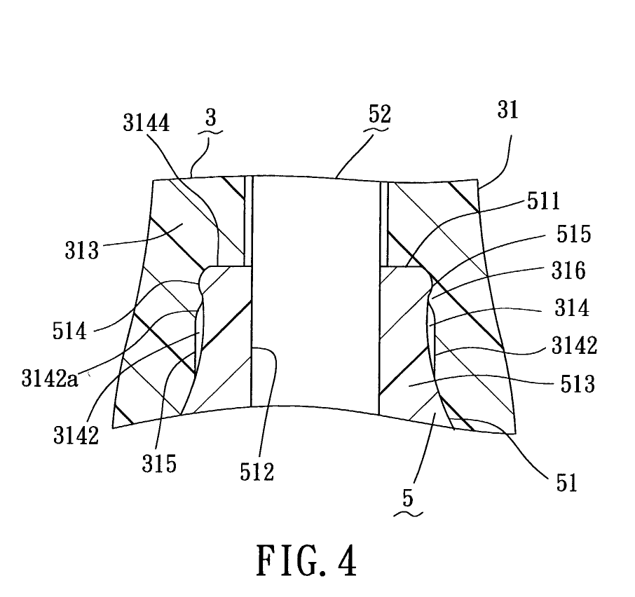

The small tool 5 includes a small handle 51 and a short shank unit 52. The small handle 51 has a front end surface 511 that is formed with a shank hole 512, a front insert portion 513 that is received within the tool-storing hole 314 in the large handle 31, and a front end flange 514 that extends integrally, radially, and outwardly from a front end of the front insert portion 513 and that has a rear edge 515. The rear edge 515 is disposed in front of and abuts against the projections 316 so as to confine the small handle 51 within the tool-storing hole 314, as best illustrated in FIG. 4. The small handle 51 further has a holding portion 516 opposite to the front insert portion 513 so as to facilitate holding of the small tool 5 by the user. The front end 511 of the small handle 51 is enlarged so as to form the front end flange 514. The widest portion of the small handle 51 has a diameter (L2), which is designed to be slightly smaller than the diameter (L1) at the rear end of the rear hole portion 3142 of the tool-storing hole 314 in the large handle 31 so that the front insert portion 513 of the small handle 51 is received fittingly within the rear hole portion 3142 of the tool-storing hole 314 in the large handle 31, and so that the front end surface 511 of the small handle 51 abuts against the shoulder 3144 of the large handle 31.

The short shank unit 52 is shorter than the long shank unit 32, and has a front working end 53 that is adapted to turn the threaded workpiece, and a rear engaging end 54 that is inserted into the shank hole 512 in the small handle 51 and that is connected detachably and non-rotatably to the small handle 51. The short shank unit 52 includes a short shank body 521 that is shorter than the long shank body 323 and that is formed with the rear engaging end 54 of the short shank unit 52, and a tool bit 522 that is formed with the front working end 53 of the short shank unit 52 and that has a rear end 523 that is connected detachably and non-rotatably to the short shank body 521. The short shank unit 52 extends into the front hole portion 3141 of the tool-storing hole 314 in the large handle 31. The structure of the short shank unit 52 is substantially similar to the long shank unit 32, the difference residing primarily in their lengths.

Referring to FIG. 4, the projections 316 on the inner wall face 315 of the large handle 31 are located at a front end (3142a) of the rear hole portion 3142 of the tool-storing hole 314 so as to retain the front end flange 514 of the small handle 51 between the shoulder 3144 and the projections 316 of the large handle 31, thereby arresting movement of the small handle 51 within the tool-storing hole 314 in the large handle 31.

When the large tool 3 and the small tool 5 are separated from each other, the long shank unit 32 of the large tool 3 and the short shank unit 52 of the small tool 5 can work independently. When the large and small tools 3, 5 are engaged so as to form one body, the front insert portion 513 of the small handle 51 is disposed within the rear hole portion 3142 of the tool-storing hole 314 in the large tool 3, and the front working end 53 of the short shank unit 52 of the small tool 5 is disposed within the front hole portion 3141 of the tool-storing hole 314 in the large tool 3.

The advantage of the hand tool assembly 2 of the present invention is that the small tool 5 and the large tool 3 can be easily engaged and disengaged due to the configurations of the tool-storing hole 314 in the large handle 31 and the front end flange 514 of the small handle 51.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A hand tool assembly comprising:
a large tool including
a large handle having a front end surface that is formed with a rearwardly extending shank hole, and a rear end surface that is formed with a frontwardly extending tool-storing hole that is defined by an inner wall face, said inner wall face being formed with a plurality of projections arranged along a circumferential direction of said large handle, and
a long shank unit having a front working end that is adapted to turn a threaded workpiece, and a rear engaging end that is inserted into said shank hole in said large handle and that is connected detachably to said large handle; and
a small tool including
a small handle having a front end surface that is formed with a shank hole, a front insert portion that is received within said tool-storing hole in said large handle, and a front end flange that extends integrally, radially, and outwardly from a front end of said front insert portion and that has a rear edge, said rear edge being disposed in front of and abutting against said projections so as to confine said small handle within said tool-storing hole, and
a short shank unit shorter than said long shank unit and having a front working end that is adapted to turn the threaded workpiece, and a rear engaging end that is inserted into said shank hole in said small handle and that is connected detachably to said small handle.

2. The hand tool assembly of claim 1, wherein said long shank unit includes a long shank body that is formed with said rear engaging end of said long shank unit, and a tool bit that is formed with said front working end of said long shank unit and that has a rear end that is connected detachably to said long shank body.

3. The hand tool assembly of claim 2, wherein said short shank unit includes a short shank body that is shorter than said long shank body and that is formed with said rear engaging end of said short shank unit, and a tool bit that is formed with said front working end of said short shank unit and that has a rear end that is connected detachably to said short shank body.

4. The hand tool assembly of claim 3, wherein said tool-storing hole in said large handle has a uniform-diameter front hole portion and a rearwardly diverging rear hole portion that has a minimum diameter at a front end, the minimum diameter being larger than the uniform diameter of said front hole portion so as to define a shoulder between said front and rear hole portions, said front insert portion of said small handle being received fittingly within said rear hole portion of said tool-storing hole in said large handle, said front end surface of said small handle abutting against said shoulder of said large handle, said short shank unit extending into said front hole portion.

5. The hand tool assembly of claim 4, wherein said projections are located at a front end of said rear hole portion so as to retain said front end flange between said shoulder and said projections, thereby arresting movement of said small handle within said tool-storing hole in said large handle.
